(19) United States
(12) Patent Application Publication
(10) Pub. No.: US 2014/0279539 A1
(43) Pub. Date: Sep. 18, 2014

(54) SYSTEMS AND METHODS FOR PROVIDING AUTOMATED TIPPING SUGGESTIONS

(71) Applicants: Jeremy Rephlo, Washington, DC (US); Lawrence Douglas, McLean, VA (US); Thomas S. Poole, Chantilly, VA (US)

(72) Inventors: Jeremy Rephlo, Washington, DC (US); Lawrence Douglas, McLean, VA (US); Thomas S. Poole, Chantilly, VA (US)

(73) Assignee: Capital One Financial Corporation, McLean, VA (US)

(21) Appl. No.: 14/209,594

(22) Filed: Mar. 13, 2014

Related U.S. Application Data
(60) Provisional application No. 61/788,462, filed on Mar. 15, 2013.

(51) Int. Cl. G06Q 20/22

(52) U.S. Cl. CPC G06Q 20/29
USPC 705/44

(57) ABSTRACT

The disclosed embodiments include methods, systems, and articles of manufacture for providing tipping suggestion services. A financial service provider configures a financial service account for a user. After the user makes a purchase at a merchant associated with leaving a tip, such as a restaurant, the financial service provider may determine metrics related to tipping, such as the user's own tipping behavior, or the tipping behavior of other users at the same merchant over time. The financial service provider may rapidly transmit the tipping metrics to a client device when a notification is received that a user has made a tip-eligible purchase, so that the user may factor the metrics into a decision of how much to tip in real time as the decision is being made.

### CROSS-REFERENCE TO RELATED APPLICATIONS

This application claims priority under 35 U.S.C. §119 to U.S. Provisional Application No. 61/788,462, filed on Mar. 15, 2013, which is expressly incorporated herein by reference in its entirety.

### BACKGROUND

Tipping and leaving gratuities are parts of everyday life for the modern consumer. Meals, haircuts, and various other goods and services are customarily associated with the custom of leaving a tip for the provider of that good or service. Consumers, however, often struggle with how much to tip in a given situation. Even in industries where tipping is relatively standardized, i.e. a certain percentage of the original bill, math must be done quickly and sometimes in situations that become uncomfortable or awkward for both the consumer and merchant. Accordingly, there is a need to timely provide consumers with relevant information related to tipping at the time the consumer must make tipping/gratuity decisions.

### SUMMARY

Disclosed embodiments include methods, systems, and articles of manufacture for providing tipping suggestion services. In one embodiment, the computing system may receive transaction information relating to a user purchase authorization associated with a user financial service account. Additionally, the computing system may determine a merchant associated with the authorization based on the received transaction information. The computing system may determine whether the merchant is associated with tipping. Further, the computing system may determine tipping history information for the user associated with the determined merchant. The computer system may additionally provide the user with the tipping history information.

In another embodiment, a method for offering tipping suggestions is disclosed. The method includes receiving transaction information relating to a user purchase authorization associated with a user financial service account. Additionally, the method includes determining classifications of merchants associated with tipping. The method further includes determining a merchant associated with the authorization based on the received transaction information, and additionally determining whether the merchant is associated with a tipping classification. The method also include determining, via one or more processors, tipping history information for the user associated with the determined merchant. The method concludes by providing the user with the tipping history information.

In yet another embodiment, a computing system may receive a plurality of indications of authorization amounts associated with purchases made by users using an account provided by one or more financial service providers over a period of time. The system may transmit authorization information to one or more financial service systems associated with one or more financial service providers corresponding to the purchases. Further, the system may receive a plurality of indications of settlement amounts associated with the purchases, and also transmit settlement amount information to the financial service system based on the received indications of settlement amounts. Additionally, the system may receive tipping information from the one or more financial service systems relating to tipping amounts during the period of time based on the authorization amounts and settlement amounts paid by users for the purchases.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1 is a block diagram of an exemplary system, consistent with disclosed embodiments.

FIG. 2 is a block diagram of another exemplary system, consistent with disclosed embodiments.

FIG. 3 is a block diagram of another exemplary system, consistent with disclosed embodiments.

FIG. 4 is a flowchart of an exemplary tipping suggestion process, consistent with disclosed embodiments.

FIG. 5 is a flowchart of an exemplary tipping information compilation process, consistent with disclosed embodiments.

FIG. 6 is a flowchart of an exemplary user tipping data determination process, consistent with disclosed embodiments.

FIG. 7 is a flowchart of an exemplary merchant tipping data determination process, consistent with disclosed embodiments.

FIG. 8 is a flowchart of an exemplary tipping information transmission process, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

FIG. 1 is a block diagram of an exemplary system 100 for performing one or more operations consistent with the disclosed embodiments. In one embodiment, system 100 may include one or more financial service provider systems 110, one or more clients devices 120, one or more merchant systems 130, and network 140. The components and arrangement of the components included in system 100 may vary. Thus, system 100 may include other components that perform or assist in the performance of one or more processes consistent with the disclosed embodiments.

Components of system 100 may be computing systems configured to provide a tipping suggestion service consistent with disclosed embodiments. As further described herein, components of system 100 may include one or more computing devices (e.g., computer(s), server(s), etc.), memory storing data and/or software instructions (e.g., database(s), memory devices, etc.), and other known computing components. In some embodiments, the one or more computing devices are configured to execute software instructions stored on one or more memory devices to perform one or more operations consistent with the disclosed embodiments. Components of system 100 may be configured to communicate with one or more other components of system 100, including financial service provider system 110, client devices 120, merchant systems 130, and/or Tipping Suggestion System 150. In certain aspects, users may operate one or more components of system 100 to initiate one or more operations consistent with the disclosed embodiments. In some aspects, the one or more users may be employees of, or associated with, the entity corresponding to the respective component(s) (e.g., someone authorized to use the underlying computing systems or otherwise act on behalf of the entity). In other aspects, the user may not be an employee or otherwise associated with underlying entity. In still other aspects, the user may itself be the entity associated with the respective component (e.g., user 122 operating client device 120).

Financial service provider system(s) 110 may be a system associated with an entity providing financial services. For example, financial service provider system 110 may be associated with a bank, credit card issuer, or other type of financial service entity that generates, provides, manages, and/or maintains financial service accounts for one or more users. Financial service accounts may include, for example, credit card accounts, loan accounts, checking accounts, savings accounts, reward or loyalty program accounts, and/or any other type of financial service account known to those skilled in the art. Financial service provider system 110 may include infrastructure and components that are configured to generate and/or provide financial service accounts such as credit card accounts, checking accounts, debit card accounts, loyalty or reward programs, lines of credit, and the like. According to some embodiments, financial service provider system 110 may be configured to offer a tipping suggestion service. For example, financial service provider system 110 may offer the tipping suggestion service as part of financial service account offerings.

Client device(s) 120 may include one or more processors configured to execute software instructions stored in memory, such as memory included in client device 120. Client device 120 may include software that when executed by a processor performs known Internet-related communication and content presentation processes. For instance, client device 120 may execute software that generates and displays interfaces and/or content on a presentation device included in, or connected to, client device 120. Client device 120 may be a mobile device that executes mobile device applications and/or mobile device communication software that allows client device 120 to communicate with components over network 140. The disclosed embodiments are not limited to any particular configuration of client device 120.

Merchant system(s) 130 may be computing systems associated with merchant entities that provide goods, services, and/or information such as a retailer, grocery store, service provider (e.g., restaurants, bars, clubs, salons, and maid services etc.), or any other type of entity that provides goods, services, and/or information that consumers (i.e., end-users or other business entities) may purchase, consume, use, etc. Merchant system(s) 130 is not limited to systems associated with merchant(s) that conduct business in any particular industry or field.

Merchant system 130 may be associated with a merchant brick and mortar location(s) that a consumer (e.g., user 122) may physically visit and purchase goods and services. Such physical locations may include merchant system 130, which may include computing devices that perform financial service transactions with consumers (e.g., Point of Sale (POS) terminal(s), kiosks, etc.). Merchant system 130 may also include back- and/or front-end computing components that store data and execute software instructions to perform operations consistent with disclosed embodiments, such as computers that are operated by employees of the merchant (e.g., back office systems, etc.). Merchant system 130 may also be associated with a merchant that provides goods and/or service via known online or e-commerce type of solutions. For example, such a merchant may sell goods via a website using known online or e-commerce systems and solutions to market, sell, and process online transactions. Merchant system 130 may include server(s) that are configured to execute stored software instructions to perform operations associated with a merchant, including one or more processes associated with processing purchase transactions, generating transaction data, generating product/service data (e.g., SKU data) relating to purchase transactions, etc.

Tipping Suggestion System 150 may be computing systems associated with entities that provide tipping suggestion services to users, merchants, or other entities capable of employing data reflecting consumer tips and gratuities. In some embodiments, Tipping Suggestion System 150 may be a subsystem of Financial service system 110, 210, as depicted in FIG. 2. Tipping Suggestion System 150, however, is not limited to systems associated with merchant(s) that conduct business in any particular industry or field. In some embodiments, Tipping Suggestion System 150 may host or otherwise provide tipping suggestion service accounts to one or more of consumers (such as users 120, 220), merchants, financial service providers, etc. In some embodiments, the tipping suggestion service accounts may be financial service accounts.

Network 140 may be any type of network configured to provide communications between components of system 100. For example, network 140 may be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 may communicate directly through a dedicated communication link(s), such as links between financial service provider system 110, client devices 120, merchant systems 130, and Tipping Suggestion System 150.

FIG. 2 is a block diagram of another exemplary system 200 for performing one or more operations consistent with the disclosed embodiments. In certain embodiments, financial service provider system 210 may include Tipping Suggestion System 150 and otherwise be configured to provide guidance on tipping behavior to client device 220 and user 222. Consistent with disclosed embodiments, financial service provider system 210 may use or otherwise directly communicate with computing devices of other elements of system 200 via computing elements (e.g., server 211). Furthermore, financial service provider 210 may directly access memory devices (not shown) to retrieve, for example, financial transaction data associated with a user 222. Financial service provider 210 may otherwise be configured and operate similar to financial service provider system 110 disclosed above in connection with FIG. 1. Similarly, client devices 220 and merchant systems 230 may be configured and operate similar to similarly labeled components disclosed above in connection with FIG. 1.

It is to be understood that the configuration and boundaries of the functional building blocks of systems 100 and 200 have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

FIG. 3 shows an exemplary system 300 for implementing embodiments consistent with the present disclosure. Variations of exemplary system 300 may be used by financial service provider system 110, client devices 120, merchant systems 130, and/or Tipping Suggestion System 150. In one embodiment, system 300 may include a server 311 having one or more processors 321, one or more memories 323, and one or more input/output (I/O) devices 322. Alternatively, server 311 may take the form of a mobile computing device, general purpose computer, a mainframe computer, or any combination of these components. According to some embodiments, server 311 may comprise web server(s) or similar computing devices that generate, maintain, and provide web site(s) consistent with disclosed embodiments. Server 311 may be standalone, or it may be part of a subsystem, which may be part of a larger system. For example, server 311 may represent distributed servers that are remotely located and communicate over a network (e.g., network 140) or a dedicated network, such as a LAN. Server 311 may correspond to server 211, or separately to any server or computing device included in financial service provider system 110, client devices 120, merchant systems 130, and/or Tipping Suggestion System 150.

Processor 321 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in server 311.

Memory 323 may include one or more storage devices configured to store instructions used by processor 321 to perform functions related to disclosed embodiments. For example, memory 323 may be configured with one or more software instructions, such as program(s) 324 that may perform one or more operations when executed by processor 321. The disclosed embodiments are not limited to separate programs or computers configured to perform dedicated tasks. For example, memory 323 may include a single program 324 that performs the functions of the server 311, or program 324 could comprise multiple programs. Additionally, processor 321 may execute one or more programs located remotely from server 311. For example, financial service provider system 110, client devices 120, merchant systems 130, and/or Tipping Suggestion System 150, may, via server 311 access one or more remote programs that, when executed, perform functions related to certain disclosed embodiments. Memory 323 may also store data 325 that may reflect any type of information in any format that the system may use to perform operations consistent with the disclosed embodiments.

I/O devices 322 may be one or more devices configured to allow data to be received and/or transmitted by server 311. I/O devices 322 may include one or more digital and/or analog communication devices that allow server 311 to communicate with other machines and devices, such as other components of systems 100 and 200.

Server 311 may also be communicatively connected to one or more database(s) 327. Server 311 may be communicatively connected to database(s) 327 through network 140. Database 327 may include one or more memory devices that store information and are accessed and/or managed through server 311. By way of example, database(s) 327 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, system 300 may include database 327. Alternatively, database 327 may be located remotely from the system 300. Database 327 may include computing components (e.g., database management system, database server, etc.) configured to receive and process requests for data stored in memory devices of database(s) 327 and to provide data from database 327.

FIG. 4 shows a flowchart of an exemplary tipping suggestion process 400, consistent with disclosed embodiments. In certain embodiments, financial service provider system (e.g., system 110, 210), client devices (e.g. devices 120, 220) and/or merchant system (130, 230) may execute software instructions to perform one or more aspects of the tipping suggestion process of FIG. 4. As an example, FIG. 4 is disclosed in connection with financial service provider system 210.

In one aspect, financial service provider system 210 may configure a financial service account for a user (e.g., user 122, 222) (Step 410). In some embodiments, configuring the account may include setting up a new account for the disclosed tipping service, or it may entail altering account parameters for an existing account, such as a financial service account, to include the disclosed tipping service. FIG. 4 will be described in connection with financial service provider system 210 as the financial service account provider, but it is understood that other components may provide an account to user 222, such as merchant systems (130, 230). In some embodiments, financial service provider system 210 may collect account information for purposes of configuring a financial service account. The financial service account information may include the identity of the account provider, the identity of an account (e.g., account number(s), etc.), the identity of other accounts (e.g., one or more financial accounts of the user that may be associated with the tipping service), and/or credentials that enable the automated tipping suggestion system to access, receive, and/or store information relating to the user's account. In some embodiments, the financial service account information may include aggregated data from cohorts of other users 222 determined to be similar to user 222 and have previously completed purchase transactions with merchant system 230. In some embodiments, the determination of other users 222 that are similar to user 222 may be made based on age, nationality, geographical location, financial status, or other factors.

Financial service provider system 210 may receive a notification of one or more purchase transactions made using a financial account from financial service provider system 210 (Step 420). The notification may comprise, for example, a request to disperse funds from an account of user 130, 230 to one or more entities based on an authorization provided by user 122, 222 (via, e.g., client device 120, 220) in return for goods or services rendered by a merchant associated with merchant system 130, 230. The purchase transactions may occur in various locations in various ways, such as at a point of sale in a brick-and-mortar location of merchant systems 230 or through network 140 via an Internet Web site associated with merchant systems 230.

Financial service provider system 210 may acquire, collect, and store information about the purchase transaction(s) (Step 430). In one aspect, merchant systems 230 may provide the transaction information to financial service provider system 210 in response to a request by financial service provider system 210 or automatically based on periodic reporting mechanisms. The transaction information may include data about user 222, such as demographic information, value of transaction, types of goods purchased, consumer history with merchant 130 or other merchants, etc. The transaction information may also include information or data about the consumer, merchant, merchant terminal, transaction, or financial account. In one aspect, merchant systems 230 may provide the transaction information directly to database 327 for storage and access by financial service provider system 210, or alternatively, transmit the information via network 140. The processes and mechanisms used for collecting transaction information are exemplary and the disclosed embodiments are not limited to the above examples. Financial service provider system 210, client devices 220, and merchant 230 may each be configured to collect, store, and monitor transaction information using other types of technologies, methodologies, and processes familiar to those skilled in the art.

Financial service provider system 210 may also perform a tipping information compilation process (Step 440), such as is disclosed below in connection with FIG. 5. According to some embodiments, financial service provider system 210 may associate the user with one or more other users of Tipping Suggestion System 150 based on information reflected in the users' respective financial service accounts. Tipping Suggestion System 150 may use the user profile information to create, update, edit, or otherwise manage tipping suggestions for the user.

Financial service provider system 210 may perform a tipping information transmission process (Step 450), such as is disclosed below in connection with FIG. 8. In some aspects, the tipping information transmission process may involve one or more network-enabled computing devices (e.g., one or more client devices 120, 220). According to some embodiments, the one or more client devices 120 may include one or more software programs for installation. The software program(s) may be an .exe file, a mobile app, a shared object (e.g., a Dynamic Link Library (DLL)), etc. Regardless of form, the software program may enable client device(s) 120, 220 to an interface and communicate interactions of a user (e.g., user 122, 222) to financial service provider system 210.

FIG. 5 shows a flowchart of an exemplary tipping information compilation process 500, consistent with disclosed embodiments. In certain embodiments, financial service provider system (e.g., system 110, 210), client devices (e.g. devices 120, 220) and/or merchant system (130, 230) may execute software instructions to perform the tipping information compilation process of FIG. 5. As an example, FIG. 5 is disclosed in connection with financial service provider system 210.

At Step 510, financial service provider system 210 may determine one or more merchants are associated with the purchase transactions made in Step 420 of tipping suggestion process 400. At Step 520, financial service provider system 210 may determine if merchant system 130 is a merchant associated with tipping or gratuities. This may be determined by data preloaded into server 211, or it may be determined via other means, such as pre-programming relating to merchant classification codes. As non-limiting examples, merchants associated with tipping or gratuities may include restaurants, bars, clubs, salons, and maid services. If the merchant associated with the purchase transactions is not associated with tipping or gratuities (Step 520: NO), then the process terminates. If the merchant associated with the purchase transactions is associated with tipping (Step 520: YES), then financial service provider system 210 may determine if user 222 has previous purchase transaction history at merchant 230 (Step 530).

Financial service provider system 210 may determine the user 222 purchase history at the merchant by various means (Step 530: YES). In some embodiments, identifying historical purchase information associated with user 222 and merchant 230 may be searched against entries in a database, such as database 327. In other embodiments, memory or memory devices associated with merchant system 230 may be searched. Financial service provider system 210 may additionally search internal memory 323 for identifying information related to user 222 and/or merchant system 230, such as user 222 information derived from magnetic strip swipes, authorization or settlement purchase transactions provided through a payment network to a card issuer, processor, or merchant, information obtained from the mobile device's operating system (e.g. location, phone number, unique device identifier, IP address, etc.), data entered into the device and stored locally (e.g. application settings, preferences, etc.), or third parties' systems that may provide additional information about the merchant 230 or user 222. These examples are not intended to be limiting, and financial service provider system 210 may use any available means to determine the user 222 purchase history at the merchant.

If user 222 has previous purchase transaction history at merchant 230 (Step 530: YES), then financial service provider system 210 may perform a user tipping data determination process (Step 540) and a merchant tipping data determination process (Step 550). An example of a user tipping data determination process is disclosed below in connection with FIG. 6, and an example of a merchant tipping data determination process is disclosed below in connection with FIG. 7. If user 222 does not have previous purchase transaction history at merchant 230 (Step 530: NO), then financial service provider system 210 may proceed directly to the merchant tipping data determination process of Step 550.

In some embodiments, financial service provider system 210 may determine whether merchant system 230 is associated with the tipping suggestion service. In some embodiments, one or more merchants may have previously elected to participate in the tipping suggestion service, and receive tipping information data for purposes of self-evaluation or business development. Data reflecting merchant participation may be preloaded into server 211, or it may be determined via other means, such as pre-programming relating to merchant classification codes. Alternatively, if the merchant system 230 is not associated with the tipping suggestion service, then financial service provider system 210 may provide the merchant with a request to participate in the tipping suggestion service. For example, in some embodiments, financial service provider system 210 may request participation of the merchant in the tipping suggestion service and receive merchant registration information in response to the request. If the merchant responds affirmatively to a request to participate in the tipping suggestion service, then financial service provider system 210 may periodically transmit tipping information data to merchant system 230. In some embodiments, the transmitted data may be associated with merchant system 230's own business. In other embodiments, the transmitted data may be associated with competitors or similar businesses of merchant system 230.

FIG. 6 shows a flowchart of an exemplary user tipping data determination process 600, consistent with disclosed embodiments. In certain embodiments, financial service provider system (e.g., system 110, 210), client devices (e.g. devices 120, 220) and/or merchant system (130, 230) may execute software instructions to perform the user tipping data determination process of FIG. 6. As an example, FIG. 6 is disclosed in connection with financial service provider system 210 performing the process of FIG. 6.

At Step 610, financial service provider system 210 may retrieve all historical user purchase transaction authorization data associated with merchant system 230 and a financial service account of the user provided by financial service provider system 210. As used herein, “purchase transaction authorizations” are defined as preliminary payment agreements between a user, such as user 222, and a merchant, such as merchant system 230, for goods and/or services, which do not include—but leave the ability to add—a tip or gratuity to the preliminary payment agreement amount. As an example, when dining at a restaurant (e.g., merchant system 230), an employee of the restaurant may present user 222 with a bill for the food and drinks purchased by user 222. User 222 may then present a payment card associated with the financial service account configured by financial service provider system 210. The restaurant employee may then swipe the payment card, preliminarily charging the underlying financial service account for the billed amount of food and drink. Financial service provider system 210 may transmit a signal to merchant 230, in this case, the restaurant, and authorize payment on the account of user 222 for the billed amount of food and drink. The payment receipt and the payment card are then presented back to user 222 for a signature, constituting user 222's agreement to pay the billed amount, and the opportunity to add a tip or gratuity. Thus, in this example, the billed amount of food before a tip is added constitutes the “purchase transaction authorization.” This example is not intended to be limiting and may depend on the configurations of financial service provider system 210 and merchant system 230 such that the purchase transaction authorization may occur in other ways.

Financial service provider system 210 may determine historical purchase transaction authorizations by user 222 at merchant system 230 by various means. In some embodiments, identifying information associated with user 222 and merchant 230 may be searched against entries in a database, such as database 327. In other embodiments, an internal database associated with merchant system 230 may be searched. In other embodiments, memory or memory devices associated with merchant system 230 may be searched. Financial service provider system 210 may additionally search internal memory 323 for identifying information related to user 222 and/or merchant system 230, such as user 222 information derived from magnetic strip swipe data or other indications of purchase transactions associated with a unique merchant classification code for merchant system 230. These examples are not intended to be limiting, and financial service provider system 210 may use any available means to determine historical purchase transaction authorizations by user 222 at merchant system 230.

At Step 620, financial service provider system 210 may retrieve all historical user purchase transaction settlement data associated with merchant system 230 and the financial service account configured by financial service provider system 210. As used herein, “purchase transaction settlements” are defined as final payment agreements between a user, such as user 222, and a merchant, such as merchant system 230, for goods and/or services, that includes any tip or gratuity. Continuing the restaurant example described above, after the payment receipt and the payment card are presented back to user 222, user 222 may elect to add a tip or gratuity to the amount indicated by the purchase transaction authorization. At a later time, merchant system 230 may enter the amount added (i.e., the tip) to the amount indicated by the purchase transaction authorization and transmit the total (i.e., billed amount plus tip added) to financial service provider system 210, which comprises the “settlement” amount. This example is not intended to be limiting; depending on the configurations of financial service provider system 210 and merchant system 230, purchase transaction settlement may occur in other ways.

Financial service provider system 210 may collect or otherwise determine the historical purchase transaction settlements associated with a user 222 and merchant system 230 by various means. In some embodiments, identifying information associated with user 222 and merchant 230 may be searched against entries in a database, such as database 327. In other embodiments, an internal database associated with merchant system 230 may be searched. In other embodiments, memory or memory devices associated with merchant system 230 may be searched. Financial service provider system 210 may additionally search internal memory 323 for identifying information related to user 222 and/or merchant system 230, such as user 222 information derived from magnetic strip swipes, authorization or settlement purchase transactions provided through a payment network to a card issuer, processor, or merchant, information obtained from the mobile device's operating system (e.g. location, phone number, unique device identifier, IP address, etc.), data entered into the device and stored locally (e.g. application settings, preferences, etc.), or third parties' systems that may provide additional information about the merchant 230 or user 222, or other indications of purchase transactions associated with a unique merchant classification code for merchant system 230. These examples are not intended to be limiting, and financial service provider system 210 may use any available means to determine historical purchase transaction settlements by user 222 at merchant system 230.

Financial service provider system 210 may match or otherwise compare the determined historical purchase transaction authorization data and the determined historical purchase transaction settlement data for user 222 in purchase transactions associated with merchant system 230 on a transaction by transaction basis (Step 630). Financial service provider system 210 may match the historical purchase transaction authorization data and the historical purchase transaction settlement data in various ways. In some embodiments, financial service system 210 may provide a common value or unique key in the authorization and settlement records so that the records may be easily matched with confidence. In other embodiments, the matching comparison may occur based on a combination of available fields. In some embodiments, the matching may occur via an exact matching process. In other embodiments, the matching may occur via a fuzzy matching process. In some embodiments, identifying information associated with the individual purchase transactions may be searched against entries in a database, such as database 327. In other embodiments, an internal database associated with merchant system 230 may be searched. In other embodiments, memory or memory devices associated with merchant system 230 may be searched. Financial service provider system 210 may additionally search internal memory 323 for identifying information related to user 222 and/or merchant system 230, such as user 222 information derived from magnetic strip swipes, authorization or settlement purchase transactions provided through a payment network to a card issuer, processor, or merchant, information obtained from the mobile device's operating system (e.g. location, phone number, unique device identifier, IP address, etc.), data entered into the device and stored locally (e.g. application settings, preferences, etc.), or third parties systems that may provide additional information about the merchant 230 or user 222, and purchase transactions associated with a unique merchant classification code for merchant system 230. These examples are not intended to be limiting, and financial service provider system 210 may use any available means to match the historical purchase transaction authorization data and the historical purchase transaction settlement data for user 222 associated with merchant system 230.

Financial service provider system 210 may determine the respective tip or gratuity amount for each transaction based on the matched purchase transaction authorization data and purchase transaction settlement data (Step 640). In some embodiments, the tip or gratuity amount may be determined by subtracting the authorization amount from the settlement amount. In other embodiments, the tip or gratuity amount may be determined from other information or data, such as physical or electronic copies of payment receipts or bills signed by user 222. In other embodiments, the tip or gratuity amount may be determined from records owned by merchant system 230 and stored in database 327, or on memory or memory devices associated with merchant system 230 accessible by financial service provider system 210.

Financial service provider system 210 may determine various tipping statistics, metrics, or information associated with historical tipping amounts paid by user 222 (Step 650). For example, in one embodiment, financial service provider system 210 may determine the average tip or gratuity amount left by user 222 for all purchase transactions across all merchants 230. In another embodiment, financial service provider system 210 may determine the average tip or gratuity amount left by user 222 for all purchase transactions across all merchants 230 in a certain classification, such as “fine dining” restaurants. In another example, financial service provider system 210 may determine the average tip or gratuity amount left by user 222 for all purchase transactions associated with merchants whose merchant classification codes indicate them to be a restaurant. In another embodiment, financial service provider system 210 may determine the average tip or gratuity amount left by user 222 for all purchase transactions at a specific merchant associated with merchant system 230. As an illustrative example, financial service provider system 210 may determine the average tip or gratuity amount left by user 222 for all purchase transactions associated with that restaurant. In some embodiments, financial system 210 may determine the distribution or standard deviation of tips or gratuities left by user 222 to enable additional analysis of tipping behavior over time.

In one embodiment, financial service provider system 210 may determine the highest tip or gratuity amount historically left by user 222 for all purchase transactions across all merchants 230. In another embodiment, financial service provider system 210 may determine the highest tip or gratuity amount historically left by user 222 for all purchase transactions across all merchants 230 in a certain classification. For example, financial service provider system 210 may determine the highest tip or gratuity amount historically left by user 222 for all purchase transactions determined to be associated with merchants who are classified in financial service provider system 210 as a restaurant. In some embodiments, the classification may be by merchant classification code. In another embodiment, financial service provider system 210 may determine the highest tip or gratuity amount historically left by user 222 for all purchase transactions at a specific merchant associated with merchant system 230.

In one embodiment, financial service provider system 210 may determine the lowest tip or gratuity amount historically left by user 222 for all purchase transactions across all merchants 230. In another embodiment, financial service provider system 210 may determine the lowest tip or gratuity amount historically left by user 222 for all purchase transactions across all merchants 230 in a certain classification. For example, financial service provider system 210 may determine the lowest tip or gratuity amount historically left by user 222 for all purchase transactions associated with merchants whose merchant classification codes indicate them to be a restaurant. In another embodiment, financial service provider system 210 may determine the lowest tip or gratuity amount historically left by user 222 for all purchase transactions at a specific merchant associated with merchant system 230. In other embodiments, financial service provider system 210 may determine the range of tip or gratuity amounts. The range may be depicted in highest/lowest amounts (i.e., $1.25-$10), percentage of total bill (i.e., 3%-25%), etc.

In one embodiment, financial service provider system 210 may determine the most recent tip or gratuity amount historically left by user 222 for all purchase transactions across all merchants 230. In another embodiment, financial service provider system 210 may determine the most recent tip or gratuity amount historically left by user 222 for all purchase transactions across all merchants 230 in a certain classification. For example, financial service provider system 210 may determine the most recent tip or gratuity amount historically left by user 222 for all purchase transactions associated with merchants whose merchant classification codes indicate them to be a restaurant. In another embodiment, financial service provider system 210 may determine the most recent tip or gratuity amount historically left by user 222 for all purchase transactions at a specific merchant associated with merchant system 230.

In determining the tipping and gratuity metrics, financial service provider system 210 may determine that certain tip and gratuity amounts are irregular or “outliers” that bias the other amounts. In one example embodiment, user 222 may leave a tip in cash, while paying for the remainder of the purchase transaction on the payment card associated with the financial service account configured by financial service provider system 210. As a result, the authorization amount and the settlement amount for that particular transaction is identical, and thus in Step 640 financial service provider system 210 would determine the tip amount left to be zero. In another example embodiment, user 222 may be dining or purchasing goods and services with other users 222. User 222 may choose to place the tip or gratuity for the entire transaction on the payment card associated with the financial service account configured by financial service provider system 210, not just the amount for the goods and services for which the user personally paid. As a result, the authorization amount and the settlement amount for that particular transaction differ by an atypical amount, and thus, in Step 640, financial service provider system 210 may determine a tip amount left to a merchant that is higher than is truly representative. Consequently, in some embodiments financial service provider system 210 may flag or otherwise indicate that these irregular or outlier tip amounts should not be considered in determination of tipping and gratuity metrics associated with user 222 (via, i.e., tipping suggestion service account). In some embodiments, financial service provider system 210 may choose to exclude all tip amounts of zero. In other embodiments, financial service provider system 210 may choose to exclude all tip amounts exceeding a certain percentage of the authorization amount if an outlier. After determining the tipping and gratuity metrics associated with user 222, financial service provider system 210 may store the metrics in database 327, in memory 323, or in other databases, memories, or memory devices associated with financial service provider system 210, client devices 220, or merchant system 230. The metrics may be associated with a financial service account of the user.

FIG. 7 shows a flowchart of an exemplary merchant tipping data determination process 700, consistent with disclosed embodiments. In certain embodiments, financial service provider system (e.g., system 110, 210), client devices (e.g., client devices 120, 220) and/or merchant system (130, 230) may execute software instructions to perform the user tipping data determination process of FIG. 7. As an example, FIG. 7 is disclosed in connection with financial service provider system 210 performing the process of FIG. 7.

At Step 710, financial service provider system 210 may retrieve all historical user purchase transaction authorization data associated with merchant system 230 for all users 222 associated with financial service accounts provided by financial service provider system 210. In some embodiments, a subset of the users 222 associated with financial service accounts provided by financial service provider system 210 may be used. Financial service provider system 210 may determine historical user purchase transaction authorization data associated with merchant system 230 by various means. In some embodiments, identifying information associated with users 222 and merchant 230 may be searched against entries in a database, such as database 327. In other embodiments, an internal database associated with merchant system 230 may be searched. In other embodiments, memory or memory devices associated with merchant system 230 may be searched. Financial service provider system 210 may additionally search internal memory 323 for identifying information related to users 222 and/or merchant system 230, such as users 222 information derived from magnetic strip swipes, and purchase transactions associated with a unique merchant classification code for merchant system 230. These examples are not intended to be limiting, and financial service provider system 210 may use any available means to determine historical purchase transaction authorizations by users 222 at merchant system 230.

At Step 720, financial service provider system 210 may retrieve all historical user purchase transaction settlement data associated with merchant system 230 for all users 222 associated with financial service accounts configured by financial service provider system 210. In some embodiments, a subset of the users 222 associated with financial service accounts provided by financial service provider system 210 may be used. Financial service provider system 210 may determine historical purchase transaction settlements by users 222 associated with merchant system 230 by various means. In some embodiments, identifying information associated with users 222 and merchant 230 may be searched against entries in a database, such as database 327. In other embodiments, an internal database associated with merchant system 230 may be searched. In other embodiments, memory or memory devices associated with merchant system 230 may be searched. Financial service provider system 210 may additionally search internal memory 323 for identifying information related to users 222 and/or merchant system 230, such as user 222 information derived from magnetic strip swipes, and purchase transactions associated with a unique merchant classification code for merchant system 230. These examples are not intended to be limiting, and financial service provider system 210 may use any available means to determine historical purchase transaction settlements by users 222 at merchant system 230.

Financial service provider system 210 may match or otherwise compare corresponding historical purchase transaction authorization data and historical purchase transaction settlement data for all users 222 in purchase transactions associated with merchant system 230 on a transaction by transaction basis (Step 730). In some embodiments, a subset of the users 222 associated with financial service accounts provided by financial service provider system 210 may be used. Financial service provider system 210 may match the historical purchase transaction authorization data and the historical purchase transaction settlement data by various means. In some embodiments, identifying information associated with the individual purchase transactions may be searched against entries in a database, such as database 327. In other embodiments, an internal database associated with merchant system 230 may be searched. In other embodiments, memory or memory devices associated with merchant system 230 may be searched. Financial service provider system 210 may additionally search internal memory 323 for identifying information related to users 222 and/or merchant system 230, such as user 222 information derived from magnetic strip swipes, and purchase transactions associated with a unique merchant classification code for merchant system 230. These examples are not intended to be limiting, and financial service provider system 210 may use any available means to match the historical purchase transaction authorization data and the historical purchase transaction settlement data for all users 222 associated with merchant system 230. In alternative embodiments, aggregate authorization data and settlement data may be compared rather than matching the data on a transaction by transaction basis.

Financial service provider system 210 may determine the respective tip or gratuity amounts for each transaction for all users 222 in which purchase transaction authorization data and purchase transaction settlement data are matched (Step 740). In some embodiments, the tip or gratuity amount may be determined by subtracting the authorization amount from the settlement amount. In other embodiments, the tip or gratuity amount may be determined from other information or data, such as physical or electronic copies of payment receipts or bills signed by various users 222. In other embodiments, the tip or gratuity amount may be determined from records owned by merchant system 230 and stored in database 327, or on memory or memory devices associated with merchant system 230 accessible by financial service provider system 210.

Financial service provider system 210 may determine various tipping statistics, metrics, or information associated with historical tipping amounts paid by all users 222 associated with purchase transactions conducted in relation to merchant system 230 (Step 750). In one embodiment, financial service provider system 210 may determine the average tip or gratuity amount left by all users 222 for all purchase transactions at a specific merchant associated with merchant system 230. In another embodiment, financial service provider system 210 may determine the highest tip or gratuity amount historically left by any user 222 for all purchase transactions at a specific merchant associated with merchant system 230. In another embodiment, financial service provider system 210 may determine the lowest tip or gratuity amount historically left by any user 222 for all purchase transactions at a specific merchant associated with merchant system 230. In another embodiment, financial service provider system 210 may determine a range of tipping amounts according to various metrics known those of skill in the art. In another embodiment, financial service provider system 210 may determine the most recent tip or gratuity amount historically left by any user 222 for all purchase transactions at a specific merchant associated with merchant system 230.

In determining the tipping and gratuity metrics, financial service provider system 210 may determine that certain tip and gratuity amounts are irregular, or “outliers” that bias the other amounts. In one example embodiment, a user 222 may leave a tip in cash, while paying for the remainder of the purchase transaction on the payment card associated with the financial service account configured by financial service provider system 210. As a result, the authorization amount and the settlement amount for that particular transaction is identical, and thus in Step 740 financial service provider system 210 would determine the tip amount left to be zero. In another example embodiment, a user 222 may be dining or purchasing goods and services with other users 222. User 222 may choose to place the tip or gratuity for the entire transaction on the payment card associated with the financial service account configured by financial service provider system 210, not just the amount for the goods and services that they personally paid for. As a result, the authorization amount and the settlement amount for that particular transaction differ by an atypical amount, and thus in Step 740 financial service provider system 210 would determine the tip amount left to higher than is truly representative. Consequently, in some embodiments financial service provider system 210 may flag or otherwise indicate that these irregular or outlier tip amounts should not be considered in determination of tipping and gratuity metrics associated with user 222. In some embodiments, financial service provider system 210 may choose to exclude all tip amounts of zero. In other embodiments, financial service provider system 210 may choose to exclude all tip amounts exceeding a certain percentage of the authorization amount. After determining the tipping and gratuity metrics associated with user 222, financial service provider system 210 may store the metrics in database 327, in memory 323, or in other databases, memories, or memory devices associated with financial service provider system 210, client devices 220, or merchant system 230.

FIG. 8 shows a flowchart of an exemplary tipping information transmission process 800, consistent with disclosed embodiments. In certain embodiments, financial service provider system (e.g., system 110, 210), client devices (e.g. devices 120, 220) and/or merchant system (130, 230) may execute software instructions to perform the tipping information transmission process of FIG. 8. As an example, FIG. 8 is disclosed in connection with financial service provider system 210 performing the process of FIG. 8.

At Step 810, financial service provider system 210, via input/output device 322, may configure and provide user interface software relating to presentation of tipping information data to client devices 120, 220. In some embodiments, the user interface may take the form of a mobile application, or “app.” In one embodiment, the app may be associated with financial service provider system 210. In another embodiment, the app may be associated with merchant system 230.

In other embodiments, the user interface may take the form of a webpage accessible on the Internet via network 140, 240 on client devices 120, 220. In yet other embodiments, the user interface may be formatted to fit in a text or SMS message transmitted to client devices 120, 220. Regardless of implementation, a user may be able to customize tipping preferences or otherwise modify a tipping suggestion service account associated with the after logging into the interface software.

Financial service provider system 210 may determine which tipping and gratuity metrics from user tipping data determination process 600 to provide to client devices 120, 220 (Step 820). Based on predetermined criteria, such as preferences set by any or all of financial service provider system 210, client devices 120, 220, users 122, 222, and merchant system 230, financial service provider system 210 may determine select ones of the user tipping and gratuity metrics to display on client devices 120, 220. Thus, in one example, financial service provider system 210 may provide the average tip provided by a user at a particular restaurant to client devices 120, 220. In some embodiments, the presentation of the displayed tipping information may be structured as a question. As an example, the display may read “Do you want to tip 18% today?” In alternative embodiments, the presentation may be presented as a comparison among a larger subset of users 222. As an example, the display may read “People like you tip an average of 18% at this merchant.”

Financial service provider system 210 may determine which tipping and gratuity metrics from merchant tipping data determination process 700 to provide to client devices 120, 220 (Step 830). Based on predetermined criteria, such as preferences set by any or all of financial service provider system 210, client devices 120, 220, users 122, 222, and merchant system 230, financial service provider system 210 may determine select ones of the merchant tipping and gratuity metrics to display on client devices 120, 220. Thus, in one example, financial service provider system 210 may provide the average tip provided by all customers of a particular restaurant.

Financial service provider system 210, via input/output device 322 and network 240, may transmit the selected user tipping and gratuity metrics and merchant tipping and gratuity metrics to client devices 120, 220 (Step 840). The transmission may occur by various means of communication, such as telephone, SMS messaging, mobile application communication, iOS push notification (with or without an accompanying alert), Google Alerts™ MMS messaging, etc. In one embodiment, the transmission may occur automatically when financial service provider system 210 receives notification of a purchase transaction authorization from merchant 230 associated with a payment account held by user 222. In such an example, the user may receive an indication of his/her tipping habits at that restaurant, as well as the tipping habits of others that have completed a purchase transaction at the restaurant, before being presented with an opportunity to add a tip or gratuity to a credit card authorization for a food bill payment. In another embodiment, user 222 may initiate the transmission themselves at their convenience. In some embodiments, user 222 may be able to manually configure preferences for tipping suggestions in certain cases. In some embodiments, user 222 may be able to override tipping suggestions based on merchant classification, or by other methods. In another embodiment, the transmission may occur automatically at various set time intervals, including but not limited to hourly, daily, weekly, monthly, quarterly, yearly, or on a fiscal year basis.

In some embodiments, merchant system 230 may utilize user tipping and gratuity metrics and merchant tipping and gratuity metrics for various business purposes. In some embodiments, merchant system 230 may utilize the metrics as internal feedback of service performance. Higher tip amounts may be associated with better service performance, and merchant system 230 may set goals for its business and employees based on the metrics. In some embodiments, merchant system 230 may set goals for a particular brick and mortar location of its business based on the tipping and gratuity metrics. In other embodiments, merchant system 230 may set goals for a geographical region of its business based on the tipping and gratuity metrics. In other embodiments, merchant system 230 may set goals for its entire workforce based on the tipping and gratuity metrics. In still other embodiments, merchant system 230 may set wages for employees of the associated merchant based on the tipping and gratuity metrics. In some embodiments, merchant system 230 may utilize the metrics of individual users 222 using identifying data. As an example, merchant system 230 may provide special rewards, perks, or other beneficial treatment to users 222 whose average tip is above the average for all tippers associated with one or more merchants 230. In some embodiments, merchant system 230 may be configured such that tipping and gratuity metrics are available for individual staff members. In these embodiments, merchant system 230 may utilize the tipping and gratuity metrics as performance measures for individual staff members. In some embodiments, merchant system 230 may set performance goals for individual staff members based on the tipping and gratuity metrics.

In some embodiments, financial service provider system 210 may utilize user tipping and gratuity metrics and merchant tipping and gratuity metrics for various business purposes. Financial service provider system 210 may utilize the metrics to generate reports regarding various merchants 230. In some embodiments, the generated reports may highlight merchants 230 with exemplary customer service as evidenced by the metrics. In other embodiments, the generated reports may highlight merchants 230 with poor customer service as evidenced by the metrics. Financial service provider system 210 may further sell information related to the metrics to outside entities for business purposes and business development. In some embodiments, various goods and services may be marketed to users 222 based on their tipping habits. As an example, in some embodiments users 222 whose average tip is below the average for all tippers associated with one or more merchants 230 may be marketed goods and services based on saving money, pursuing do-it-yourself home repairs, etc. In alternative embodiments, users 222 whose average tip is above the average for all tippers associated with one or more merchants 230 may be marketed goods and services based on luxury items.

Other embodiments will be apparent to those skilled in the art from consideration of the specification and practice of the disclosed embodiments. It is intended that the specification and examples be considered as exemplary only, with a true scope and spirit of the disclosed embodiments being indicated by the following claims. Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

What is claimed is:

1. A system for offering tipping suggestions, comprising:
a memory storing instructions; and
a processor configured to execute the instructions to:
receive transaction information relating to a user purchase authorization associated with a user financial service account;
determine a merchant associated with the authorization based on the received transaction information;
determine whether the merchant is associated with tipping;
determine tipping history information for the user associated with the determined merchant; and
provide the user with the tipping history information.

2. The system of claim 1, wherein the one or more processors are further configured to:
identify one or more merchant classifications of offered products and/or services;
determine a classification associated with the merchant; and
determine if the classification associated with the merchant is a classification associated with a tip leaving classification.

3. The system of claim 1, wherein determining tipping history information for the user associated with the determined merchant comprises configuring the processor to execute the instructions to:
retrieve all historical user purchase transaction authorizations associated with the user and the determined merchant;
retrieve all historical user purchase transaction settlements associated with the user and the determined merchant;
compare all historical user purchase transaction authorizations and purchase transaction settlements associated with the determined merchant;
determine tip amounts for each purchase transaction based on the authorizations and settlements associated with the determined merchant; and
determine user tipping metrics associated with historical user purchase transactions.

4. The system of claim 3, wherein determining user tipping metrics associated with historical user purchase transactions comprises configuring the processor to execute the instructions to:
determine at least one of average tip amount, maximum tip amount, minimum tip amount, or most recent tip amount.

5. The system of claim 1, wherein the one or more processors are further configured to:
determine tipping history information for all users associated with the determined merchant.

6. The system of claim 5, wherein determining tipping history information for all users associated with the determined merchant comprises configuring the processor to execute the instructions to:
retrieve all historical purchase transaction authorizations for all users associated with the determined merchant;
retrieve all historical purchase transaction settlements for all users associated with the determined merchant;
compare all historical purchase transaction authorizations and purchase transaction settlements for all users associated with the determined merchant;
determine tip amounts for each purchase transaction based on the authorizations and settlements for all users associated with the determined merchant; and
determine merchant tipping metrics associated with historical user purchase transactions.

7. The system of claim 6, wherein determining user tipping metrics associated with historical user purchase transactions comprises configuring the processor to execute the instructions to:
determine at least one of average tip amount, maximum tip amount, minimum tip amount, or most recent tip amount associated with all users associated with the determined merchant.

8. A method for offering tipping suggestions, comprising:
receiving transaction information relating to a user purchase authorization associated with a user financial service account;
determining classifications of merchants associated with tipping;
determining a merchant associated with the authorization based on the received transaction information;
determining whether the merchant is associated with a tipping classification;
determining, via one or more processors, tipping history information for the user associated with the determined merchant; and
providing the user with the tipping history information.

9. The method of claim 8, wherein determining whether the merchant is associated with a tipping classification comprises:
identifying one or more merchant classifications of offered products and/or services;
determining a classification associated with the merchant; and
determining if the classification associated with the merchant is a classification associated with a tip leaving classification.

10. The method of claim 8, wherein determining tipping history information for the user associated with the determined merchant comprises:
retrieving all historical user purchase transaction authorizations associated with the user and the determined merchant;
retrieving all historical user purchase transaction settlements associated with the user and the determined merchant;
comparing all historical user purchase transaction authorizations and purchase transaction settlements associated with the determined merchant;
determining tip amounts for each purchase transaction based on the authorizations and settlements associated with the determined merchant; and
determining user tipping metrics associated with historical user purchase transactions.

11. The method of claim 10, wherein determining user tipping metrics associated with historical user purchase transactions comprises determining at least one of average tip amount, maximum tip amount, minimum tip amount, or most recent tip amount.

12. The method of claim 8, further comprising:
determining, via the one or more processors, tipping history information for all users associated with the determined merchant.

13. The method of claim 12, wherein determining tipping history information for all users associated with the determined merchant comprises:
retrieving all historical purchase transaction authorizations for all users associated with the determined merchant;
retrieving all historical purchase transaction settlements for all users associated with the determined merchant;
comparing all historical purchase transaction authorizations and purchase transaction settlements for all users associated with the determined merchant;
determining tip amounts for each purchase transaction based on the authorizations and settlements for all users associated with the determined merchant; and
determining merchant tipping metrics associated with historical user purchase transactions.

14. The method of claim 13, wherein determining merchant tipping metrics associated with historical user purchase transactions comprises determining at least one of average tip amount, maximum tip amount, minimum tip amount, or most recent tip amount associated with all users associated with the determined merchant.

15. A system for offering tipping suggestions to a customer, comprising:
a memory storing instructions; and
a processor configured to execute the instructions to:
receive a plurality of indications of authorization amounts associated with purchases made by users using an account provided by one or more financial service providers over a period of time;
transmit authorization information to one or more financial service systems associated with one or ore financial service providers corresponding to the purchases;
receive a plurality of indications of settlement amounts associated with the purchases;
transmit settlement amount information to the one or more financial service systems based on the received indications of settlement amounts; and
receive tipping information from the one or more financial service systems relating to tipping amounts during the period of time based on the authorization amounts and settlement amounts paid by users for the purchases.

16. The system of claim 15,
wherein the one or more financial service systems determine the tipping information based on receiving authorization and settlement data associated with merchants, matching the authorization and settlement data on a transaction-by-transaction basis, and determining tipping amounts based on the difference between the authorization and settlement amounts for each transaction during the period of time.

17. The system of claim 15,
wherein the one or more financial service systems determine the tipping information based on comparing aggregate authorization and settlement data, and determining tipping amounts based on the difference between the authorization and settlement amounts for each transaction during the period of time.

18. The system of claim 15, wherein the received tipping information comprises merchant tipping metrics associated with user purchase transactions during the period of time.

19. The system of claim 18, wherein the merchant tipping metrics comprise at least one of average tip amount, maximum tip amount, minimum tip amount, or most recent tip amount.

20. The system of claim 19, wherein the merchant tipping metrics are associated with individual employees of the merchant.
